(19) United States
(12) Patent Application Publication
(10) Pub. No.: US 2020/0343539 A1
(43) Pub. Date: Oct. 29, 2020

(54) MANGANESE PHOSPHATE COATED LITHIUM NICKEL OXIDE MATERIALS

(71) Applicant: Johnson Matthey Public Limited Company, London (GB)

(72) Inventors: Dominic BRESSER, Ulm (DE); Guk-Tae KIM, Ulm (DE); Stefano PASSERINI, Ulm (DE); Zexiang SHEN, SINGAPORE (SG); Zhen CHEN, SINGAPORE (SG)

(21) Appl. No.: 16/959,255

(22) PCT Filed: Jan. 16, 2019
(86) PCT No.: PCT/GB2019/050114

§ 371 Date: Jun. 30, 2020

(30) Foreign Application Priority Data
Jan. 17, 2018 (GB) 1800742.7

(51) Int. Cl. H01M 4/36; H01M 4/505; H01M 4/58; H01M 4/525; H01M 10/0525; C01G 53/00

(52) U.S. Cl. CPC H01M 4/366; H01M 4/505; H01M 4/5825; H01M 4/525; H01M 10/0525; C01G 53/50; C01P 2002/88; C01P 2006/40; C01P 2004/80; C01P 2004/04; C01P 2002/72; C01P 2002/85; H01M 2220/20

(57) ABSTRACT

Coated lithium transition metal oxide materials are provided which have a continuous coating of manganese phosphate provided on the surface of lithium transition metal oxide particles. Coated lithium transition metal oxide materials have advantageous physical and electrochemical properties in comparison to uncoated materials.

### FIELD OF THE INVENTION

The present invention relates to materials suitable for use as cathode materials in lithium-ion batteries. In particular, the present invention relates to particulate lithium transition metal oxide materials. The present invention also provides processes for making such materials, and cathodes, cells and batteries comprising the materials.

### BACKGROUND OF THE INVENTION

Layered nickel-containing lithium transition metal oxides, derivatives of LiCoO₂, have been investigated due to their higher capacity, lower cost, better environmental benignity and improved stability compared with LiCoO₂. These materials are considered promising candidates as cathode materials for a range of applications including full electric vehicles (EVs), hybrid electric vehicles (HEVs) and plug-in hybrid electric vehicles (PHEVs), in the face of the growing interest in higher capacity and energy density. However, to meet the demanding requirements in this area, some improvements in cycling stability, rate capability, thermal stability and structural stability are desired. Side reactions between electrode and electrolyte can result in increased electrode/electrolyte interfacial resistance and can lead to transition metal dissolution, particularly at elevated temperatures and under high voltage. These problems may be more severe with increased Ni content.

Recently, the surface modification of cathode materials has drawn attention with the aim of solving the above-mentioned problems. It has been demonstrated that surface modification with metal oxides [1-3], phosphates [4-6], fluorides [7-9], and some lithium conductive metal oxides [10-12] can improve cycling stability, rate capability, and, in some cases, even thermal stability.

U.S. Pat. No. 6,921,609 describes a composition suitable for use as a cathode material of a lithium ion battery which includes a core composition having an empirical formula LiₓM′_{z}Ni_{1-y}M″_{y}O₂ and a coating on the core which has a greater ratio of Co to Ni than the core.

Cho et al [13] have described LiNi_{0.6}Co0.2Mn0.2O₂ with nano-sized crystalline Mn₃(PO₄)₂ particles deposited on its surface, leading to improved thermal stability.

### SUMMARY OF THE INVENTION

The present inventors have found that manganese phosphate is a promising candidate for depositing on the surface of particulate lithium nickel oxide materials, and have found that the nature of the manganese phosphate coating is important in providing advantageous physical and electrochemical properties to the lithium nickel oxide materials.

In particular, as demonstrated in the Examples, the present inventors have found that providing a continuous manganese phosphate coating on the surface of the particles can lead to one or more of decreased electrode polarisation, enhanced lithium ion diffusion, high rate capability, improved capacity retention and improved thermal stability.

Accordingly, in a first preferred aspect the present invention provides a coated lithium transition metal oxide material having a continuous coating of manganese phosphate provided on the surface of lithium transition metal oxide particles.

In a second preferred aspect, the present invention provides a process for providing a continuous coating of manganese phosphate on the surface of lithium transition metal oxide particles, the process comprising contacting particulate lithium transition metal oxide with a composition comprising Mn ions and phosphate ions, and heating to form the manganese phosphate coating.

Typically, the composition comprising Mn ions and phosphate ions has a Mn concentration in the range from 0.001M to 0.09M.

In a further preferred aspect, the present invention provides a coated lithium transition metal oxide material obtained or obtainable by a process described or defined herein. The material typically has a manganese phosphate coating provided on the surface of lithium transition metal oxide particles. The coating is typically continuous.

In a further preferred aspect, the present invention provides use of a coated lithium transition metal oxide according to the present invention for the preparation of a cathode of a secondary lithium battery (e.g. a secondary lithium ion battery). In a further preferred aspect, the present invention provides a cathode comprising coated lithium transition metal oxide according to the present invention. In a further preferred aspect, the present invention provides a secondary lithium battery (e.g. a secondary lithium ion battery) comprising a cathode which comprises coated lithium transition metal oxide according to the present invention. The battery typically further comprises an anode and an electrolyte.

### BRIEF DESCRIPTION OF THE DRAWINGS

FIG. 1A shows a TEM image of sample MP-NCM-1 wt % prepared in the Examples, showing a continuous coating of manganese phosphate with a thickness of about 3 nm.

FIG. 1B shows a TEM image of sample MP-NCM-2 wt % prepared in the Examples, showing a continuous coating of manganese phosphate with a thickness of about 6 nm.

FIG. 1C shows a TEM image of sample MP-NCM-3 wt % prepared in the Examples, showing large clumps of manganese phosphate coating material.

FIG. 2 shows the XRD patterns of pristine NCM (top line), MP-NCM-1 wt % (2^{nd} line), MP-NCM-2 wt % (3^{rd} line) and MP-NCM-3 wt % (bottom line).

FIG. 3 shows XPS results for pristine NCM (top line), and the MP-NCM-2 wt % (bottom line), and shows (a) wide scan; (b) C 1s; (c) P 2p; (d) Ni 2p; (e) Co 2p and (f) Mn 2p.

FIG. 4 shows cyclic voltammograms of pristine NCM (FIG. 4a), MP-NCM-1 wt % (FIG. 4b), MP-NCM-2 wt % (FIG. 4c) and MP-NCM-3 wt % (FIG. 4d).

FIG. 5 shows electrochemical characterization of pristine and coated NCM electrodes: (a) rate capability, (b) cycling performance at C/10 (100 cycles); (c) cycling performance of MP-NCM-2 wt % at 1 C, 2 C and 10 C for 100 cycles (initial 3 cycles at C/10 for activation).

FIG. 6 shows charge-discharge profiles of MP-NCM-2 wt % in the voltage range of: (a) 3.0-4.3 V, (b) 3.0-4.4 V, (c) 3.0-4.5 V at 10 C for 100 cycles; charge-discharge profiles of (d) pristine NCM, and (e) MP-NCM-2 wt % in the voltage range of 2.5-4.3 Vat 0.1 C for 100 cycles; (f) capacity retention comparison of pristine NCM and MP-NCM-2 wt % at 60° C. for 100 cycles (10 C).

FIG. 7 shows charge/discharge profiles of P-NCM622 and MP-NCM622-1 wt % at various c-rates: (a) and (d) 0.1 C; (b) and (e) 2 C; (c) and (f) 10 C for 100 cycles.

FIG. 8 shows comparative thermal stability upon 100 cycles at 10 C between P-NCM622 and MP-NCM622-1 wt % at different temperatures (a) 20° C.; (b) 40° C. and (c) 60° C.

FIG. 9 shows DSC profiles of P-NCM622 and MP-NCM622-1 wt % after charging to 4.3 V.

FIG. 10 shows comparative electrochemical performance between P-NCM622 and MP-NCM622-1 wt % (a) rate capability and (b) cycling stability at 0.1 C and 10 C for 100 cycles in the voltage range of 3.0-4.6 V.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The lithium transition metal oxide typically includes nickel. It may include one or more further transition metals, for example selected from the group consisting of cobalt, manganese, vanadium, titanium, zirconium, copper, zinc and combinations thereof. The lithium transition metal oxide may include one or more additional metals selected from the group consisting of magnesium, aluminium, boron, strontium, calcium and combinations thereof. The lithium transition metal oxide may comprise nickel and one or both of cobalt and manganese.

The lithium transition metal oxide may have a formula according to Formula I below:

LiₐNiₓM_{y}M′_{z}O_{2+b} Formula I

in which:
0.8≤a≤1.2
0.2≤x≤1
0<y≤0.8
0≤z≤0.2
−0.2≤b≤0.2
M is selected from the group consisting of Co, Mn and combinations thereof; and
M′ is selected from the group consisting of Mg, Al, V, Ti, B, Zr, Sr, Ca, Cu and Zn, and combinations thereof.

In Formula I, 0.8≤a≤1.2. It may be preferred that a is greater than or equal to 0.9, or 0.95. It may be preferred that a is less than or equal to 1.1, or 1.05.

In Formula I, 0.2≤x≤1. It may be preferred that x is greater than or equal to 0.3, 0.4, 0.5, 0.55 or 0.6. It may be preferred that x is less than or equal to 0.99, 0.98, 0.95, 0.9, 0.8 or 0.7.

In Formula I, 0<y≤0.8. It may be preferred that y is greater than or equal to 0.01, 0.02. 0.05 or 0.1. It may be preferred that y is less than or equal to 0.7, 0.6, 0.5, 0.4, 0.3, 0.2, 0.15, 0.1 or 0.05.

In Formula I, 0≤z≤0.2. It may be preferred that z is greater than 0, or greater than or equal to 0.005 or 0.01. It may be preferred that z is less than or equal to 0.15, 0.1 or 0.05. In some embodiments, z is 0 or is about 0.

Typically, 0.9≤x+y+z≤1.1. For example, x+y+z may be 1.

In Formula I, −0.2≤b≤0.2. It may be preferred that b is greater than or equal to −0.1. It may be preferred that b is less than or equal to 0.1. In some embodiments, b is 0 or about 0.

In Formula I, M′ is one or more selected from the group consisting of Mg, Al, V, Ti, B, Zr, Sr, Ca, Cu and Zn. It may be preferred that M′ is one or more selected from the group consisting of Mg and Al.

The lithium transition metal oxide may have a formula according to Formula II below:

LiₐNiₓCoᵥMn_{w}M′_{z}O_{2+b} Formula II

in which:
0.8≤a≤1.2
0.2≤x≤1
0≤v≤0.8
0≤w≤0.8
0≤z≤0.2
−0.2≤b≤0.2
M′ is selected from the group consisting of Mg, Al, V, Ti, B, Zr, Sr, Ca, Cu and Zn, and combinations thereof.

In Formula II, 0.8≤a≤1.2. It may be preferred that a is greater than or equal to 0.9, or 0.95. It may be preferred that a is less than or equal to 1.1, or 1.05.

In Formula II, 0.2≤x≤1. It may be preferred that x is greater than or equal to 0.3, 0.4, 0.5, 0.55 or 0.6. It may be preferred that x is less than or equal to 0.99, 0.98, 0.95, 0.9, 0.8 or 0.7.

In Formula II, 0≤v≤0.8. It may be preferred that v is greater than 0, or is greater than or equal to 0.01, 0.02, 0.05 or 0.1. It may be preferred that v is less than or equal to 0.7, 0.5, 0.4, 0.3, 0.2 or 0.1.

In Formula II, 0≤w≤0.8. It may be preferred that w is greater than 0, or is greater than or equal to 0.01, 0.02, 0.05, 0.1 or 0.15. It may be preferred that w is less than or equal to 0.7, 0.6, 0.5, 0.45, 0.4, 0.3, 0.25, 0.2 or 0.1.

In Formula II, 0≤z≤0.2. It may be preferred that z is greater than 0, or greater than or equal to 0.005 or 0.01. It may be preferred that z is less than or equal to 0.15, 0.1 or 0.05. In some embodiments, z is 0 or is about 0.

Typically, 0.9≤x+v+w+z≤1.1. For example, x+v+w+z may be 1.

In Formula II, −0.2≤b≤0.2. It may be preferred that b is greater than or equal to −0.1. It may be preferred that b is less than or equal to 0.1. In some embodiments, b is 0 or about 0.

In Formula II, M′ is one or more selected from the group consisting of Mg, Al, V, Ti, B, Zr, Sr, Ca, Cu and Zn. It may be preferred that M′ is one or more selected from the group consisting of Mg and Al.

The lithium transition metal oxide may, for example, be doped or undoped lithium nickel cobalt manganese oxide (NCM), or doped or undoped lithium nickel cobalt aluminium oxide (NCA). The dopant may be one or more selected from Mg, Al, V, Ti, B, Zr, Sr, Ca, Cu and Zn, e.g. selected from Mg and Al.

The skilled person will understand that the features of the composition of the lithium transition metal oxide discussed herein relate to the composition of the lithium transition metal oxide independently of the manganese phosphate coating.

In some embodiments, the lithium transition metal oxide material is a crystalline (or substantially crystalline) material. It may have the α-NaFeO₂-type structure. It may be a polycrystalline material, meaning that each particle of lithium transition metal oxide material is made up of multiple crystallites (also known as crystal grains or primary particles) which are agglomerated together. The crystal grains are typically separated by grain boundaries. Where the lithium transition metal oxide is polycrystalline, it will be understood that the particles of lithium transition metal oxide comprising multiple crystals are secondary particles. The manganese phosphate coating is typically formed on the surface of the secondary particles. It will be understood that the coated lithium transition metal oxide material is typically particulate.

The shape of the lithium transition metal oxide particles (e.g. the secondary particles) is not particularly limited. They may, for example be elongate particles (e.g. bar shaped particles), or they may be substantially spherical particles. The shape of the coated lithium transition metal oxide particles is not particularly limited. They may, for example be elongate particles (e.g. bar shaped particles), or they may be substantially spherical particles.

The lithium transition metal oxide particles have a continuous coating or film of manganese phosphate on the surface of the particles. The term continuous coating (or continuous film) is understood to refer to a coating covering each particle, the coating being formed from a layer of continuous manganese phosphate material. It is understood to exclude a coating made up from agglomerations of discrete particles, e.g. a coating where discrete particles are visible when viewed using TEM at a length scale of approximately 10 nm to 100 nm.

In some embodiments, the particles are entirely covered by the coating. It may be an MnPO₄ coating. For example, it may be preferred that no more than 10%, 5%, 1% or 0.1% of the lithium transition metal oxide particle surface is exposed.

The coating layer may be substantially uninterrupted.

The coating layer may have a substantially uniform thickness. For example, the coating thickness at its thinnest point may be at least 15%, at least 25%, at least 50% or at least 75% of the average thickness of the coating layer. This may be determined by TEM, for example determining the thickness variation for ten representative particles.

The coating layer may be amorphous. The coating layer may be considered to be amorphous if no crystalline peaks representing manganese phosphate are visible by XRD analysis of the coated particles.

The continuous coating is a manganese phosphate coating. For example, it may comprise or consist essentially of MnPO₄. The average oxidation state of the manganese in the manganese phosphate coating may be in the range 2.5-3.5, for example it may be 3.

Typically, the thickness of the continuous coating is less than or equal to 15 nm, 10 nm or 8 nm. The coating thickness may be greater than or equal to 0.5 nm, 1 nm, 2 nm, 3 nm or 4 nm. It may be particularly preferred that the coating thickness is in the range from 2 nm to 10 nm. The thickness may be determined using TEM. For example, the thickness may be determined for ten representative particles. The coating thickness may be the average (e.g. mean) coating thickness of the ten representative particles.

The manganese phosphate coating may be deposited from a composition comprising Mn ions and phosphate ions. The composition may be a solution, e.g. an aqueous solution.

The concentration of Mn ions in the composition may be in the range from 0.001M to 0.09M. It may be greater than or equal to 0.002, 0.003, 0.0035, 0.004, 0.0045, 0.005, 0.0055 or 0.006M. It may be less than or equal to 0.085, 0.08, 0.075 or 0.07M. (The concentration is calculated with reference to the total amount of Mn supplied and the total amount of liquid supplied to the lithium transition metal oxide material (i.e. Suspension C in the Examples below)).

The coated lithium transition metal oxide material may exhibit a capacity loss of less than 15%, less than 10%, less than 8% or less than 7% when cycled for 100 cycles at 1 C. The capacity loss may be determined using a Maccor series 4000 battery tester, and the cell may be cycled in galvanostatic conditions for 3 initial cycles at 0.1 C rate (activation of electrodes) followed by cycling at constant C-rate (1 C) for 100 cycles. The cell may be formed as follows:
Cathode electrodes fabricated by dispersing/dissolving each of the active materials (80 wt %), C-NERGY Super C65 (IMERYS, 15 wt %) and poly-vinylidene fluoride (PVDF6020, Solvay, 5 wt %) in N-methyl-2-pyrrolidone (NMP, Aldrich), intimately stirring the slurry to form a homogeneous dispersion, casting the slurry on an Al foil by the doctor-blade technique, immediately drying the wet electrodes at 60° C. to remove the NMP, punching disc electrodes (12 mm in diameter) and further drying under vacuum at 100° C. for 8 h. The loading of the electrode should be 2.0±0.2 mg cm⁻².
CR2032 coin cells assembled in an argon-filled glove box (with O₂<0.1 ppm and H₂O<0.1 ppm), using lithium metal as anode, 1M LiPF₆ dissolved in ethyl carbonatedimethyl carbonate (EC-DMC) (1:1 v/v) with 1 wt % of additive of vinylene carbonate (VC) as the electrolyte, single layer polyethylene membrane as separator, and cathodes prepared as described above.

The coated lithium transition metal oxide material may exhibit a lithium ion apparent diffusion coefficient on delitihation of at least 2×10⁻⁸ cm²s⁻¹, e.g. at least 2.5×10⁻⁸ cm²s⁻¹ or at least 3×10⁻⁸ cm²s⁻¹. The lithium ion apparent diffusion coefficient may be determined by performing cyclic voltammogram (CV) scans at various scan rates from 0.1 to 1.5 mV s⁻¹. The linear relationship of the peak current intensity as a function of square root of scan rate can be used to determine the apparent lithium ion diffusion coefficients according to the Randles-Sevcik equation.

The lithium transition metal oxide material may be obtained or obtainable by a process described or defined herein.

The present invention provides a process for providing a continuous coating of manganese phosphate on the surface of lithium transition metal oxide particles, the process comprising contacting particulate lithium transition metal oxide with a composition comprising Mn ions and phosphate ions, and heating to form the manganese phosphate coating.

The composition may be a solution, e.g. an aqueous solution.

The concentration of Mn ions in the composition may be in the range from 0.001M to 0.09M. It may be greater than or equal to 0.002, 0.003, 0.0035, 0.004, 0.0045, 0.005, 0.0055 or 0.006M. It may be less than or equal to 0.085, 0.08, 0.075 or 0.07M. (The concentration is calculated with reference to the total amount of Mn supplied and the total amount of liquid supplied to the lithium transition metal oxide material (e.g. Suspension C in the Examples below).)

The source of Mn ions is not particularly limited in the present invention. Typically, it is an Mn salt. Typically, the salt is soluble in water. The Mn ions may be Mn(II) or Mn(III) ions, typically Mn(II). Suitable Mn salts include Mn acetate (e.g. Mn(Ac)₂), Mn chloride, Mn gluconate and Mn sulfate. Mn(Ac)₂ may be particularly preferred.

The source of phosphate ions is not particularly limited in the present invention. Typically, it is a phosphate salt. Typically, the salt is soluble in water. Suitable phosphate salts include phosphate, hydrogen phosphate, dihydrogen phosphate and pyrophosphate salts. The counter ion is not particularly limited. It may be a non-metal counter ion, e.g. ammonium. NH₄H₂PO₄ may be particularly preferred.

The particulate lithium transition metal oxide may be contacted with the composition comprising Mn ions and phosphate ions by a process comprising
providing a solution (e.g. an aqueous solution) of Mn ions; then
mixing the solution of Mn ions with particulate lithium transition metal oxide to form a mixture; then
adding a solution comprising phosphate ions to the mixture.

The solution comprising phosphate ions may be added gradually, e.g. dropwise.

The concentration of Mn ions in the solution of Mn ions maybe less than or equal to 0.18M, 0.16M or 0.15M. It may be greater than or equal to 0.001M, 0.003M, 0.005M, 0.006M, 0.007M or 0.01M.

After contacting the particulate lithium transition metal oxide with the composition comprising Mn ions and phosphate ions, the mixture is typically dried.

The process comprises a step of heating the mixture (e.g. the dried mixture) to form the manganese phosphate coating. The heating step may involve heating to a temperature of at least 100° C., 150° C., 200° C., or 250° C. The temperature may be less than 800° C., 600° C., 400° C., or 350° C. The heating step may last for between 30 minutes and 24 hours. It may be at least 1, 2 or 4 hours. It may be less than 10 hours or 6 hours.

The heating step may be carried out in air. The Mn may be oxidised during the heating step, e.g. from Mn(II) to Mn(III). Alternatively, the heating step may be carried out in a different oxidising atmosphere, or in an inert atmosphere such as under nitrogen or argon.

The process of the present invention may further comprise the step of forming an electrode (typically a cathode) comprising the coated lithium transition metal oxide material. Typically, this is carried out by forming a slurry of the coated lithium nickel oxide, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the coated lithium transition metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention, and are not intended to limit its scope.

### EXAMPLES

1—Manganese Phosphate Coating of LiNi_{0.4}Co_{0.2}Mn_{0.4}O₂ Characterisation and Electrochemical Testing

Preparation of LiNi_{0.4}Co_{0.2}Mn0.4O₂(Pristine NCM)

1.399 g LiAc, 1.991 g Ni(Ac)₂.4H₂O, 0.996 g Co(Ac)₂.4H₂O and 1.961 g Mn(Ac)₂.4H₂O were dissolved in 200 ml of deionised water and ethanol (volume ratio of water:ethanol was 1:5) under continuous stirring until the solution became transparent (solution A). 3.880 g oxalic acid was dissolved in 200 ml of deionised water and ethanol (volume ratio of water:ethanol was 1:5) under continuous stirring until it became transparent (solution B). Solution B was added into suspension A, drop by drop, under continuous stirring for 3 h. The suspension was then dried at 60° C.

The obtained dried material was heated to 450° C. for 10 h, and then heated up to 850° C. for 20 h in a muffle furnace (air atmosphere).

Preparation of Manganese Phosphate Coated LiNi_{0.4}Co_{0.2}Mn_{0.4}O₂(MP-NCM)

LiN_{i0.4}Co_{0.2}Mn_{0.4}O₂ (Pristine NCM) was prepared as described above. An appropriate amount of Mn(Ac)₂.4H₂O to give the desired manganese loading was dissolved in 10 ml of de-ionized water (DIW) under stirring, followed by the addition of 1 g of pristine NCM under continuous stirring for 30 min (suspension A). NH₄H₂PO₄ (in the stoichiometric amount to give MnPO₄) was dissolved in 10 ml of DIW (solution B). Solution B was added into suspension A, drop by drop, under continuous stirring for 3h. The resulting suspension (suspension C) was then dried at 60° C. while being stirred. The collected powder was then heated in a muffle oven (air atmosphere) at 300° C. for 5 h to form MnPO₄-coated LiNi_{0.4}Co0.2Mn0.4O₂ (MP-NCM).

Three different amounts of MnPO₄ were added, to prepare three different samples, as set out in Table 1 below;

TABLE 1

| | Amount of manganese | | |
|---|---|---|---|
| | phosphate coating | Concentration | |
| | (wt % with respect to | of Mn in | Concentration of |
| Sample | NCM) | suspension C | Mn in solution A |
| MP-NCM- | 1 wt % | 0.0034M | 0.0067M |
| 1 wt % | | | |
| MP-NCM- | 2 wt % | 0.0067M | 0.013M |
| 2 wt % | | | |
| MP-NCM- | 3 wt % | 0.01M | 0.02M |
| 3 wt % | | | |

This enabled the evaluation of the effect of coating thickness, and coating suspension composition, on the physical and electrochemical properties of the materials.

Characterisation

TEM images were collected. The samples were ground between two glass slides and dusted onto a holey carbon coated Cu TEM grid. The samples were examined in a JEM 2800 Transmission Electron Microscope using the following instrumental conditions: Voltage (kV) 200; C2 aperture (um) 70 and 40.

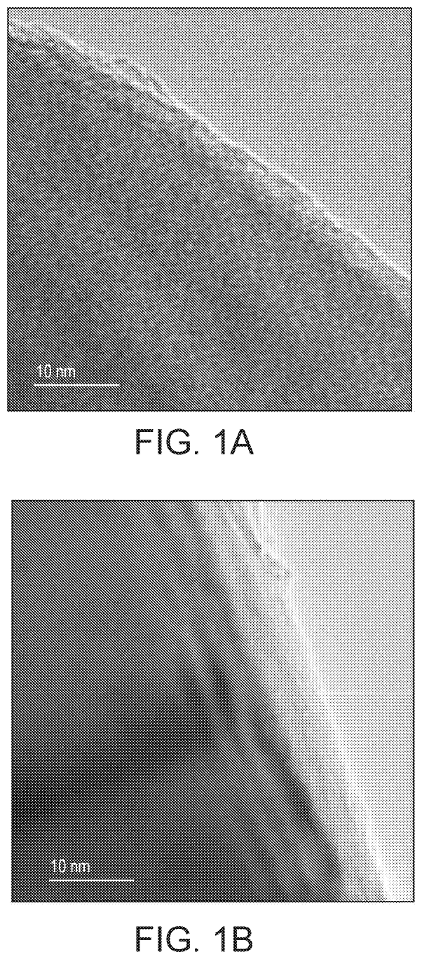

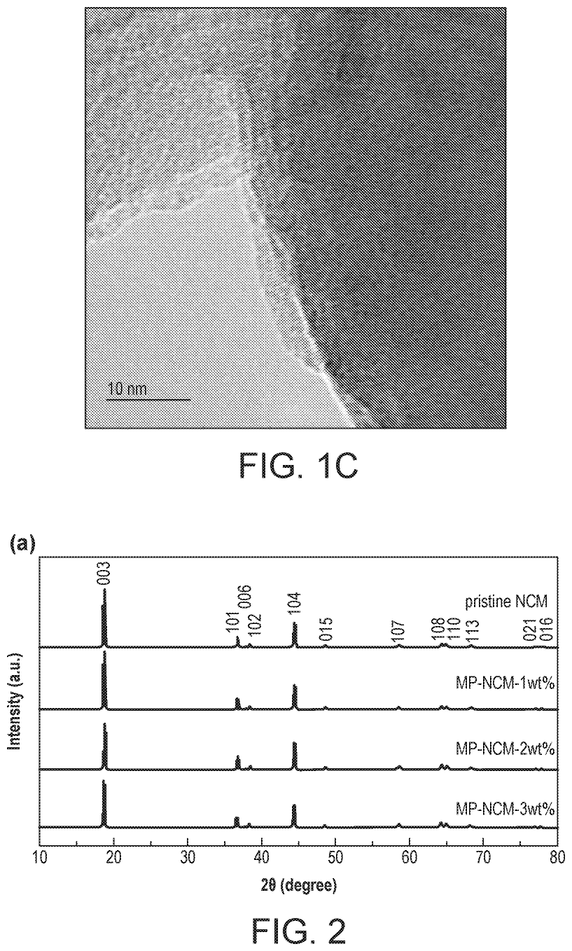

The TEM images are shown in FIG. 1A to 1C. FIG. 1A shows sample MP-NCM-1 wt %, showing an even, continuous coating of manganese phosphate with a thickness of about 3 nm. FIG. 1B shows sample MP-NCM-2 wt %, showing a continuous coating of manganese phosphate with an average thickness of about 6 nm. FIG. 1C shows sample MP-NCM-3 wt %, and shows large clumps of manganese phosphate coating material, regions with little coating, and regions with coating thicknesses in excess of 20 nm. Thus, the coating on MP-NCM-3 wt % is not continuous.

XRD patterns were identified using X-ray diffraction (Bruker D8 with Cu Kα radiation, λ=0.15406 nm). FIG. 2 shows the XRD patterns of pristine NCM (top line), MP-NCM-1 wt % (2^{nd} line), MP-NCM-2 wt % (3^{rd} line) and MP-NCM-3 wt % (bottom line). All of the diffraction patterns are in good agreement with the α-NaFeO₂ layered structure without any impurities. For all MP-NCM samples, the diffraction peaks of MnPO₄ are absent, which may indicate that the manganese phosphate coating is amorphous. The identical XRD patterns of samples both before and after coating indicate that the coating process does not interfere with the base NCM material.

X-ray photoelectron spectroscopy (XPS) measurements were performed with a PHI 5800 Multi-Technique ESCA system using a monochromatic Al Kα source (1486.6 eV) radiation. Charging effects at the surface were compensated for by low-energy electrons from a flood gun.

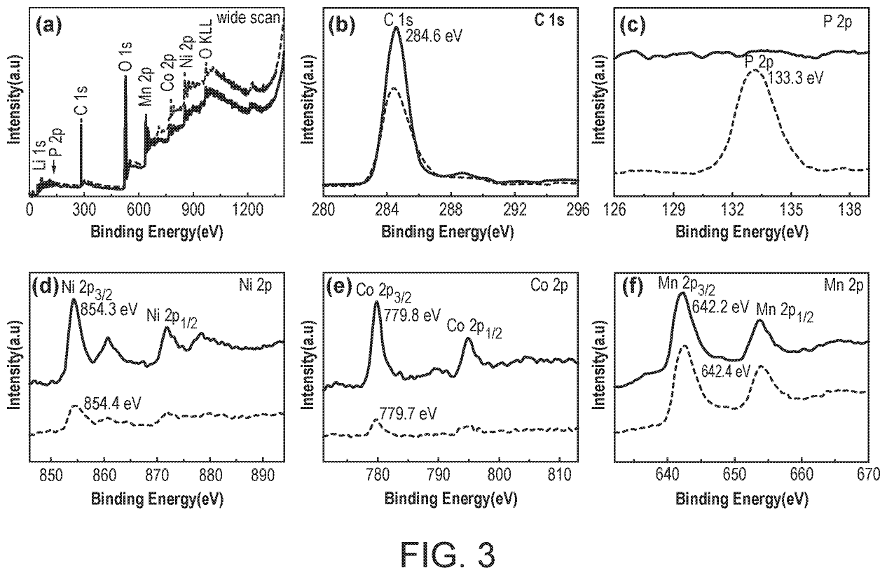

XPS was employed to investigate the effect of the coating on the oxidation states of the NCM material. The top line is pristine NCM, and the bottom line is MP-NCM-2 wt %. FIG. 3 shows (a) wide scan; (b) C 1s; (c) P 2p; (d) Ni 2p; (e) Co 2p and (f) Mn 2p. The position of the C 1s peak was used for peak calibrations.

The wide scan spectra in FIG. 3a validates the presence of all elements, i.e., Li, Ni, Co, Mn and O, in both the samples. As expected, the P 2p peak is only detected in the spectrum of MP-NCM-2 wt % (see FIG. 3c), due to the presence of the MnPO₄ coating. Its position at 133.3 eV is a characteristic of the tetrahedral PO₄ group. The peak of Ni 2p, present at a binding energy of 854.3 eV for pristine NCM and 854.4 eV for MP-NCM-2 wt % (such a minor shift is well within the experimental error), confirms the oxidation state of Ni²⁺ in both the materials. The binding energies of Co are 779.8 eV (pristine NCM) and 779.7 eV (MP-NCM-2 wt %), respectively, suggesting the trivalent state of cobalt in both samples. For the binding energy of Mn, a shift to higher oxidation state is observed from 842.2 eV (pristine NCM) to 842.4 eV (MP-NCM-2 wt %) because of the strong bonds with PO₄. Also apparent is the weakening of the C 1s, Ni 2p and Co 2p peak intensities after coating. However, since XPS measurement is a surface sensitive analysis, the peak intensity of Mn 2p is higher because of the manganese phosphate coating. Overall, the increased intensity of the XPS Mn 2p peak together with the weakened intensities of all other elements confirms the successful and uniform coating of NCM with the manganese phosphate layer.

Electrochemical Testing

Protocols

Cathode electrodes were fabricated by firstly dispersing/dissolving each of the active materials (80 wt %), C-NERGY Super C65 (IMERYS, 15 wt %) and poly-vinylidene fluoride (PVDF6020, Solvay, 5 wt %) in N-methyl-2-pyrrolidone (NMP, Aldrich). The slurries were intimately stirred to form a homogeneous dispersion, and then cast on Al foils by the doctor-blade technique. The wet electrodes were immediately dried at 60° C. to remove the

NMP. Afterwards, disc electrodes (12 mm in diameter) were punched and further dried under vacuum at 100° C. for 8 h.

CR2032 coin cells were assembled in an argon-filled glove box (with O₂<0.1 ppm and H₂O<0.1 ppm). Coin half cells were assembled using lithium metal as anode, 1M LiPF₆ dissolved in ethyl carbonate-dimethyl carbonate (EC-DMC) (1:1 v/v) with 1 wt % of additive of vinylene carbonate (VC) as the electrolyte, single layer polyethylene membrane (ASAHI KASEI, Hipore SV718) as separator, and the cathodes prepared as described above. The average loading of the electrodes was ˜2.0±0.2 mg cm⁻². For the cycling performance test with higher mass loading, electrodes were prepared with ˜4.0±0.2 and ˜6.0±0.2 mg cm⁻² loading.

The electrochemical performance of the cells was tested using a Maccor series 4000 battery tester. The cells were cycled at different C-rates (from 0.1 C to 10 C) in the range of 3.0-4.3 V vs. Li⁺/Li to investigate the rate capability.

For the cycling stability test, the cells were cycled in galvanostatic conditions for 3 initial cycles at 0.1 C rate (activation of electrodes) followed by cycling at constant C-rates (0.1 C, 1 C, 2 C and 10 C) for 100 cycles.

Cyclic voltammetry (CV) measurements were performed using a multi-channel potentiostat (VMP Biologic-Science Instruments) within the voltage range between 2.5 and 4.5 V (vs. Li⁺/Li) at controlled temperature at 20° C. Initially three CV cycles were performed at a scan rate of 0.1 mV s⁻¹ followed by other cycles at different scan rates (from 0.1 to 1.5 mV s⁻¹).

For the evaluation of cycling performance at higher temperature, pristine NCM and MP-NCM-2 wt % electrodes were cycled at 10 C for 100 cycles at 60° C., following the initial three activation cycles at 0.1 C.

Cyclic Voltammograms

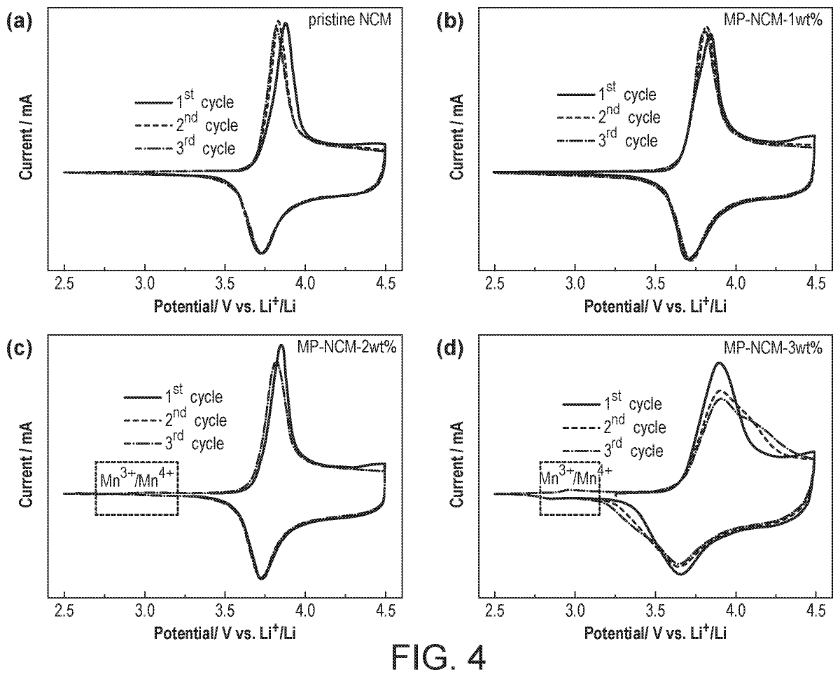

In order to investigate the effects of the manganese phosphate coating on the electrochemical performance of the active material (NCM), cyclic voltammograms of pristine NCM (FIG. 4a), MP-NCM-1 wt % (FIG. 4b), MP-NCM-2 wt % (FIG. 4c) and MP-NCM-3 wt % (FIG. 4d) were recorded at the scan rate of 0.1 mV s⁻¹ within the voltage range between 2.5 and 4.5 V. According to literature, the redox peaks appearing in the 3.7-4.0 V range correspond to the Ni²⁺/Ni⁴⁺ redox couple. Additionally, one pair of weak cathodic/anodic peaks appears around 2.7-3.0 V in the MP-NCM samples (see FIGS. 4c and 4d), corresponding to the Mn³⁺/Mn⁴⁺ redox peaks occurring in the manganese phosphate coating layer. These latter peaks are not obvious in MP-NCM-1 wt %, which is believed to be due to the low amount of coating. It is worth noting that that this redox reaction appears to be reversible on cycling, indicating stability of the coating layer even when over discharge occurs.

The anodic and cathodic peaks of pristine NCM in the first cycle are centred at 3.877 and 3.722 V with a peak separation of 0.155 V (see Table 2 below). The peak separation reduced to 0.1 V in the 3^{rd} cycle. MP-NCM-1 wt % and MP-NCM-2 wt % showed even lower peaks separations, suggesting decreased electrode polarization, which indicates better electrochemical performance. MP-NCM-2 wt % displays the smallest peak separation, i.e., the smallest electrode polarization. On the other hand, MP-NCM-3 wt % showed an increased peak separation and poor reversibility upon the three voltammetric cycles.

TABLE 2

| | 1^{st} Cycle | | 3^{rd} Cycle | |
|---|---|---|---|---|
| | Anodic/ | Peak | Anodic/ | Peak |
| | Cathodic | Separation | Cathodic | Separation |
| | (V) | (V) | (V) | (V) |
| Pristine-NCM | 3.8767/3.7219 | 0.1548 | 3.8218/3.7218 | 0.1000 |
| MP-NCM- | 3.8782/3.7266 | 0.1516 | 3.8318/3.7348 | 0.0970 |
| 1wt % | | | | |
| MP-NCM- | 3.8517/3.7331 | 0.1186 | 3.8214/3.7292 | 0.0922 |
| 2wt % | | | | |
| MP-NCM- | 3.9039/3.6681 | 0.2358 | 3.9200/3.6501 | 0.2699 |
| 3wt % | | | | |

To explore the effect of the manganese phosphate coating on the lithium ion transfer kinetics, cyclic voltammogram (CV) scans at various scan rates from 0.1 to 1.5 mV s⁻¹ were collected. The linear relationship of the peak current intensity as a function of square root of scan rate can be used for the apparent lithium ion diffusion coefficients according to the Randles-Sevcik equation. The apparent lithium ion diffusion coefficients are set out in Table 3 below.

TABLE 3

| | Lithium Ion Apparent Diffusion Coefficient | |
|---|---|---|
| | Delithiation (cm²s⁻¹) | Lithiation (cm²s⁻¹) |
| Pristine-NCM | 1.85 × 10⁻⁸ | 4.85 × 10⁻⁹ |
| MP-NCM-1 wt % | 2.24 × 10⁻⁸ | 3.89 × 10⁻⁹ |
| MP-NCM-2 wt % | 3.28 × 10⁻⁸ | 7.64 × 10⁻⁹ |

MP-NCM-2 wt % shows lithium ion apparent diffusivities of 3.28*10⁻⁸ and 7.64*10⁻⁹ cm² s⁻¹ for delithiation and lithiation processes, respectively. These values, almost twice those obtained with pristine NCM (ca. 1.85*10⁻⁸ and 4.85*10⁻⁹ cm² s⁻¹), clearly show that coating the NCM particles with a manganese phosphate layer of appropriate thickness enhances lithium ion insertion and extraction in the active material. MP-NCM-1 wt % showed improved extraction kinetics and acceptable insertion kinetics.

Cell Testing

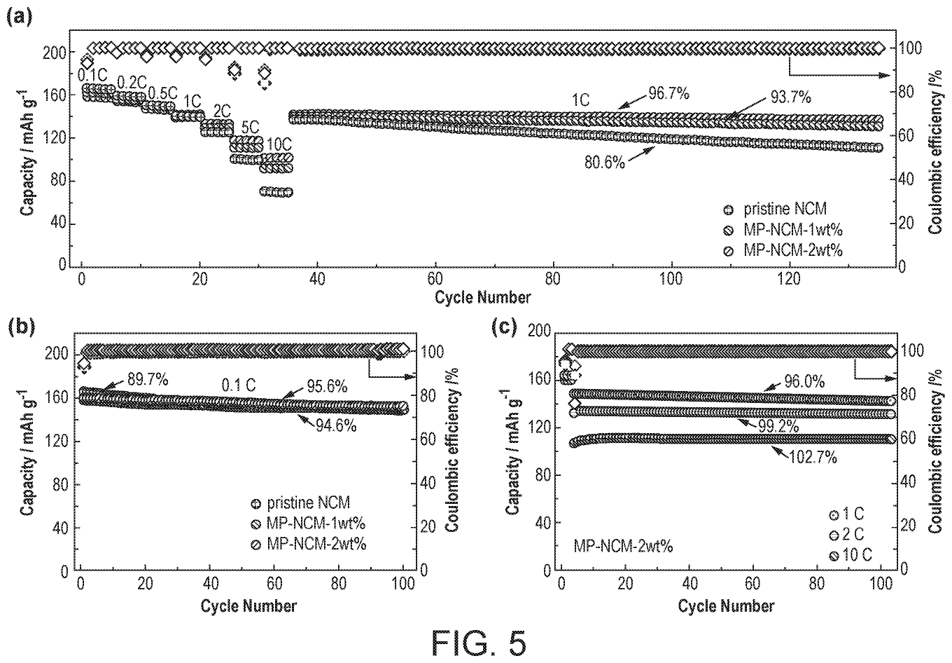

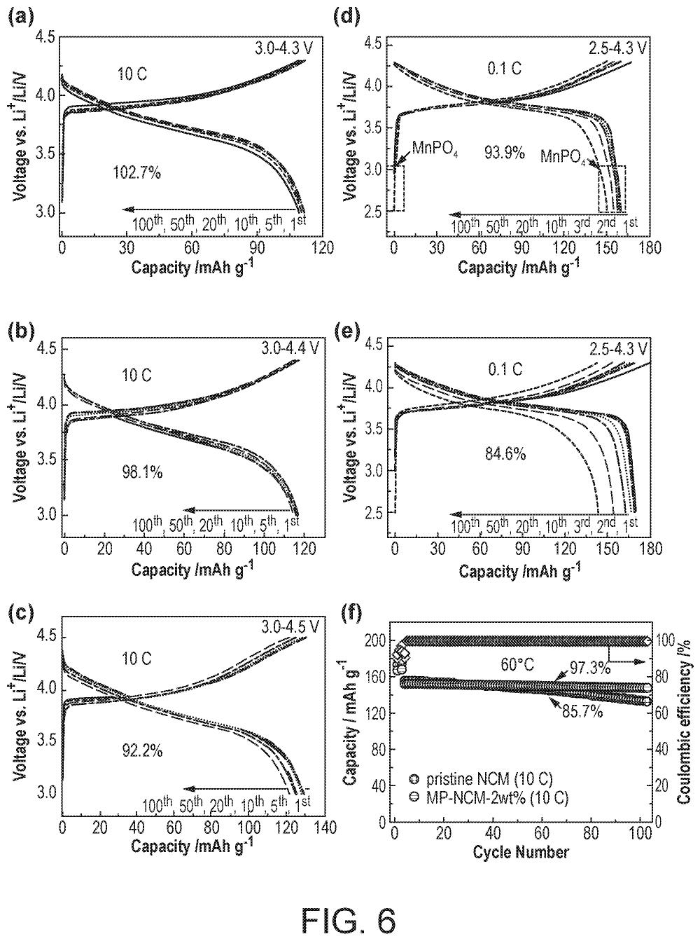

Electrodes made from pristine NCM, MP-NCM-1 wt % and MP-NCM-2 wt % were subjected to galvanostatic charge-discharge cycles at various C-rates (from 0.1 C to 10 C) and then at constant rate (1 C for 100 cycles). The results are shown in FIG. 5a. The performance of the coated samples is improved compared with the pristine NCM, approaching 100% coulombic efficiency. As expected, the capacity at lower C-rates shows a slight decrease due to the presence of the less electrochemically active coating layer.

The initial capacities of pristine NCM, MP-NCM-1 wt % and MP-NCM-2 wt % were 166.2, 162.2, and 158.6 mAh g⁻¹, respectively. At higher current rates, the capacity of the coated samples is greatly improved. At 10 C rate, MP-NCM-1 wt % and MP-NCM-2 wt % delivered capacities of 92.0 and 101.5 mAh g⁻¹, respectively, which are higher than that of pristine NCM (70.5 mAh g⁻¹). Additionally, the coated materials showed capacity losses of 6.3% and 3.3%, respectively, following 100 cycles at 1 C, while that of pristine NCM was 19.4%.

FIG. 5b compares the capacity retention upon low current rate (0.1 C) cycling of pristine NCM (89.7%), MP-NCM-1 wt % (94.6%) and MP-NCM-2 wt % (95.6%). The uncoated material shows the highest initial capacity, but is accompanied by a strong capacity fade which is believed to be due to side reactions at the interface of electrode and electrolyte (believed to be mainly transition metal dissolution). The differences between the coated samples reflect the amount (thickness) of coating material. If the coating layer is too thin, some transition metal dissolution still occurs. However, if the coating layer is too thick, increased resistance and thus larger polarization will occur, leading to severe electrochemical performance degradation. Therefore, the 2 wt % manganese phosphate coating amount is found to be the optimum condition with significantly enhanced high C-rate capability and cycling stability.

As seen in FIG. 5c, the MP-NCM-2 wt % electrodes show excellent capacity retentions as high as 95.6% (0.1 C), 96.0% (1 C), 99.2% (2 C) and 102.7% (10 C) after 100 cycles.

The excellent performance of MP-NCM-2 wt % is even more obvious when comparing the charge/discharge profiles with pristine NCM upon cycling at 0.1 C, 2 C and 10 C rates. Pristine NCM electrodes showed lowest capacity retention values, ca. 89.7% (0.1 C), 78.2% (2 C) and 78.9% (10 C). At the highest rates, the pristine electrodes showed evidence of strong polarization due to the surface modification upon cycling. The same did not occur with the MP-NCM-2 wt % electrodes because of the effective manganese phosphate coating which protects the interface from side reactions. The results are shown in Table 4 below.

TABLE 4

| | 1^{st} cycle/ | | | 10^{th} cycle/ | | | 20^{th} cycle/ | | |
|---|---|---|---|---|---|---|---|---|---|
| | mAh g⁻¹ | | | mAh g⁻¹ | | | mAh g⁻¹ | | |
| | 0.1 C | 2 C | 10 C | 0.1 C | 2 C | 10 C | 0.1 C | 2 C | 10 C |
| pristine NCM | 165.4 | 139.1 | 108.8 | 162.7 | 136.6 | 107.8 | 159.6 | 132.6 | 104.6 |
| MP-NCM-2 wt % | 159.6 | 133.4 | 109.1 | 158.9 | 134.6 | 111.6 | 157.9 | 134.3 | 111.3 |

| | 50^{th} cycle/mAh g⁻¹ | | | 100^{th} cycle/mAh g⁻¹ | | |
|---|---|---|---|---|---|---|
| | 0.1 C | 2 C | 10 C | 0.1 C | 2 C | 10 C |
| pristine NCM | 154.6 | 122.0 | 97.8 | 148.4 | 108.2 | 85.7 |
| MP-NCM-2 wt % | 155.4 | 133.3 | 111.1 | 152.6 | 131.6 | 110.5 |

Although the initial capacity of pristine NCM at both 0.1 C and 2 C (165.4 and 139.1 mAh g⁻¹) are slightly higher than those of MP-NCM-2 wt % (159.6 and 133.4 mAh g⁻¹), the latter material performance surpasses that of the former after about 20 cycles. The difference becomes more prominent during following cycles. At 10 C, MP-NCM-2 wt % delivers superior capacity than pristine NCM from the initial cycle, and the capacity gradually increased during cycling which may be due to the activation of active material, yielding 102.7% capacity retention ratio (vs. 78.9% of pristine NCM). The significantly improved high rate capability and long-term cycling stability confirm the manganese phosphate coating of NCM material as a very successful approach.

Stress Conditions—Overcharge and Overdischarge

To evaluate the performance of the coated NCM upon cycling in more stressful conditions, further cycling tests were also performed. FIGS. 6a-6c compare the cycling performance of MP-NCM-2 wt % within three different voltage ranges (3.0-4.3 V, 3.0-4.4 V and 3.0-4.5 V), showing that even when subjected to 100 cycles at 10 C the electrodes can still recover 98.1% and 92.2% of their initial capacity when charged up to 4.4 V and 4.5 V, respectively.

Although the cycling stability is reduced, with this higher upper cut-off voltage (UCV) the material still provided 115.6 (at 4.4 V) and 129.2 (at 4.5 V) mAh g⁻¹ capacity, i.e., higher than that of 107.5 mAh g⁻¹ obtained upon charging up to 4.3 V. This shows that increased UCV provides higher capacity, but with a slight reduction in capacity retention and reversibility. The effect of the manganese phosphate coating layer was also investigated upon over-discharge. In particular, the MP-NCM-2 wt % electrode was subjected to 100 cycles (at 0.1 C) with the lower cut-off voltage set to 2.5 V to examine the cycling stability in case of over-discharge. From the charge-discharge profiles (FIG. 6d), the capacity retention during cycling does not show major decay, with capacity retention ratio as high as 93.9%. The feature found in the voltage range of 2.7-3.0 V, which is absent in pristine NCM when cycled at the same conditions (FIG. 6e), is believed to be due to the redox reaction of Mn³⁺/Mn⁴⁺ occurring in the MnPO₄ coating layer. In contrast, pristine NCM only recovers 84.6% of initial capacity after 100 cycles at 0.1 C, indicating that the manganese phosphate coating layer can significantly improve the cyclability even in the case of overdischarge.

Thermal Stability of Pristine NCM and MP-NCM-2 wt % at Higher Operation Temperature (60° C.).

For the evaluation of thermal stability, pristine NCM and MP-NCM-2 wt % electrodes were cycled at 10 C in galvanostatic conditions for 100 cycles at 60 ° C. (FIG. 6f). The initial capacity of pristine NCM at 0.1 C increased to 173.1 mAh g⁻¹, which is higher than that of MP-NCM-2 wt % (166.6 mAh g⁻¹). However, after 100 cycles at 10 C, MP-NCM-2 wt % delivered 147.8 mAh g⁻¹ capacity, corresponding to 97.3% capacity retention ratio, while pristine NCM delivered only 133.0 mAh g⁻¹ with a substantially lower capacity retention (85.7%). Such a greatly enhanced stability at elevated temperature confirms the improved thermal stability of the MP-NCM-2 wt % material provided by the manganese phosphate coating.

Excellent performance is also demonstrated for MP-NCM-2 wt % in cells using an ionic liquid electrolyte.

2—Manganese Phosphate Coating of LiNi_{0.6}Co_{0.2}Mn_{0.2}O₂ Characterisation and Electrochemical Testing

Preparation of LiNi_{0.6}Co_{0.2}Mn_{0.2}O₂(Pristine NCM622, P-NCM622)

LiCH₃COO (22 mmol), Ni(CH₃COO)₂.4H₂O (12 mmol), Co(CH₃COO)₂.4H₂O (4 mmol) and Mn(CH₃COO)₂.4H₂O (4 mmol) were dissolved in a mixture of deionised water (40 mL) and ethanol (160 mL) under continuous stirring until the solution became transparent (solution A). Oxalic acid (31 mmol) was dissolved in another mixture of deionised water (40 mL) and ethanol (160 mL) under stirring until transparent (solution B). After that, solution A was poured into solution B under vigorous stirring for 6 h. The mixture was then completely dried at 60° C. using a rotary evaporator.

The obtained dried material was heated to 450° C. for 10 h, then heated to 800° C. for 20 h in a muffle furnace (air atmosphere).

Preparation of Manganese Phosphate Coated LiNi_{0.6}Co_{0.2}Mn_{0.2}O₂ (MP-NCM622)

Manganese phosphate coating was carried out as described above for LiNi_{0.4}Co_{0.2}Mn_{0.4}O₂, to provide 1 wt % manganese phosphate coating (MP-NCM622-1 wt %).

Electrochemical Testing

Electrodes and cells were prepared as described above with respect to the LiNi_{0.4}Co_{0.2}Mn_{0.4}O₂ samples, and electrochemical testing was carried out according to the same protocols.

Cycling Performance

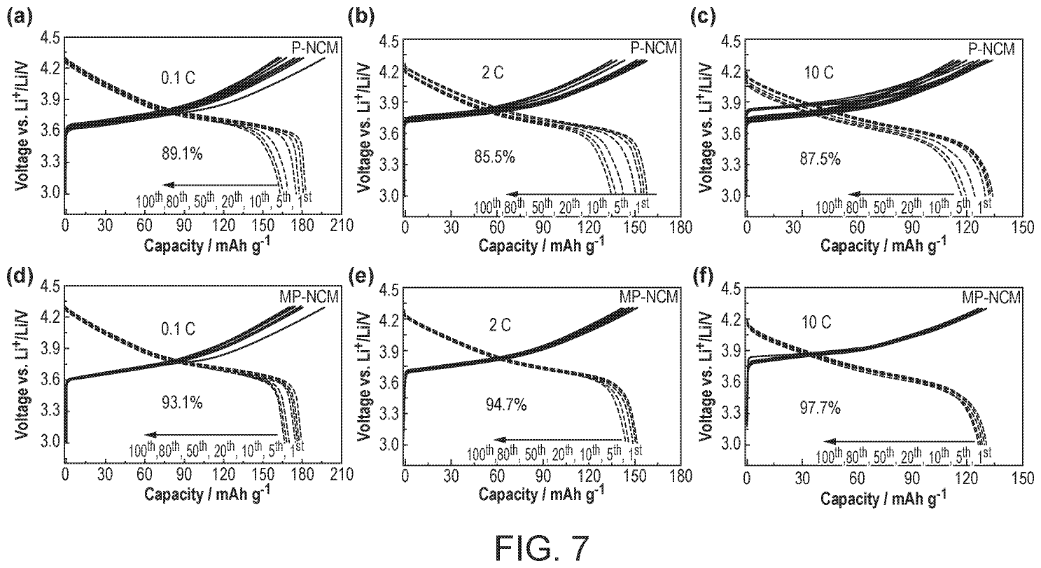

With the purpose of investigating the effects of coating material on the cycling performances, electrodes of P-NCM622 and MP-NCM622-1 wt % were tested at various C-rates (0.1 C, 2 C and 10 C) over 100 cycles. FIG. 7 shows charge/discharge profiles of P-NCM622 and MP-NCM622-1 wt %. As can be seen from FIGS. 7a and 7d, the initial discharge capacity of P-NCM622 and MP-NCM622-1 wt % at low current density (0.1 C) are 182.6 and 179.4 mA h g⁻¹ respectively with high initial Coulombic efficiency (approaching 93.3% and 94.0%, respectively). The slightly lower capacity of MP-NCM622-1 wt % is attributed to less active material contribution because of the less electrochemically active coating layer. However, after 100 cycles, MP-NCM622-1 wt % was able to achieve a capacity retention ratio of 93.1%, much higher than that of P-NCM622 (89.1%). The difference of cycling stability between P-NCM622 and MP-NCM622-1 wt % becomes even more obvious at higher current densities. For instance, after 100 cycles, MP-NCM622-1 wt % can still deliver 143.4 (2 C, FIG. 7e) and 126.2 (10 C, FIG. 7f) mA h g⁻¹ capacity with only 5.3% and 2.3% of capacity decay, respectively. In contrast, only 135.0 (2 C, FIG. 7b) and 117.5 (10 C, FIG. 7c) mA h g⁻¹ capacity were delivered in the case of P-NCM622, with 85.5% and 87.5% capacity retention ratios. Furthermore, the electrode polarization is greatly reduced in the coated sample, particularly at higher C-rates, ca. 2 C and 10 C (FIGS. 7b, c, e and f). Even at high mass loading condition (12 mg cm⁻²), the MP-NCM622-1 wt % electrode still yields 90.7% capacity retention ratio after 100 cycles at 1 C.

This demonstrates that similar advantages of the manganese phosphate coating are achieved for different lithium transition metal oxide materials.

Thermal Stability

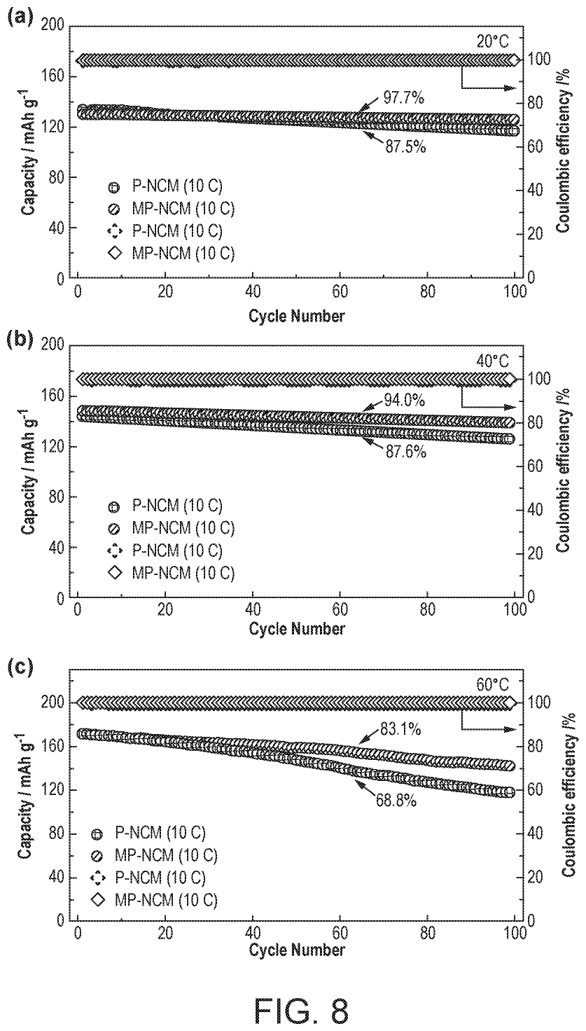

In order to evaluate thermal stability, both P-NCM622 and MP-NCM622-1 wt % electrodes were cycled at 10 C for 100 cycles at 40° C. (FIG. 8b) and 60° C. (FIG. 8c). At 40° C., the MP-NCM622-1 wt % electrode achieved 155.4 mA h g⁻¹ capacity with 94.0% capacity retention ratio after 100 cycles at 10 C, while P-NCM622 electrode delivered lower capacity (151.1 mA h g⁻¹) with 87.6% capacity recovery ratio. Compared to room temperature performance, the increased capacity delivered at elevated temperature is believed to be due to improved Li⁺ intercalation and deintercalaction. When increasing operation temperature up to 60° C., the MP-NCM622-1 wt % electrode yielded greatly enhanced capacity retention ratio (83.1%) compared with P-NCM622 (68.8%) after 100 cycles, indicating that the thermal stability of NCM622 is significantly enhanced by coating. The enhanced thermal stability indicates that manganese phosphate coated materials can form electrodes capable of working at wider operation temperatures with outstanding electrochemical performance.

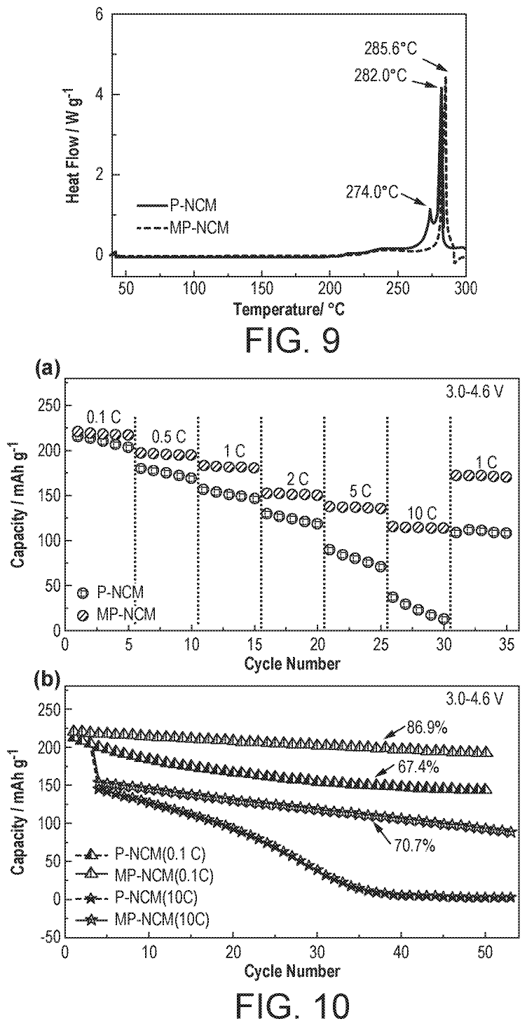

Differential Scanning calorimetry (DSC) measurements were conducted to examine the thermal behaviour changes with and without manganese phosphate coating. P-NCM622 and MP-NCM622-1 wt % electrodes were charged to 4.3 V at delithiated state. FIG. 9 compares the DSC curves of P-NCM622 and MP-NCM622-1 wt %. Upon heating, the instability of Ni⁴⁺ (Co⁴⁺) at highly delithiated states can become more pronounced, leading to liberation of oxygen from the transition metal oxide layers, triggering the decomposition of the electrolyte. The DSC profile of P-NCM622 shows a main exothermal peak centred at 282.0° C., together with a smaller peak centred at 274.0° C., generating 307.4 J g⁻¹ heat. However, in the coated sample, the onset decomposition temperature of MP-NCM622-1 wt % shifts to a higher temperature, ca. 285.6° C., with decreased heat generated (264.6 J g⁻¹). This result indicates that the coating layer is capable of preventing direct contact between the electrolyte and the unstable oxidized positive electrode, thus decreasing the severity of an exothermic reaction by suppressing unwanted surface reactions. This provides further evidence of improved thermal stability after coating.

Cycling Stability at Higher Cut-Off Voltage

For the investigation of cycling stability at higher cut-off voltage, both P-NCM622 and MP-NCM622-1 wt % electrodes were tested at various C-rates (0.1-10 C), and subjected to 50 cycles at 0.1 C and 10 C, respectively. FIG. 10a compares the rate capability of P-NCM622 and MP-NCM622-1 wt %. Initially, the capacity of MP-NCM622-1 wt % at 0.1 C (221.0 mA h g⁻¹) slightly exceeded P-NCM622 (215.8 mA h g⁻¹). With the increasing of current densities, the discharge capacities of the MP-NCM622-1 wt % electrode were 196.2, 182.0, 151.5, 136.4 and 114.5 mA h g⁻¹ at 0.5 C, 1 C, 2 C, 5 C and 10 C, respectively. In contrast, strong capacity degradation is observed for P-NCM622, i.e. 175.1 (0.5 C), 151.6 (1 C), 124.2 (2 C), 80.0 (5 C), 22.9 (10 C) mA h g¹. When cycled back to 1 C after high current density test, MP-NCM622-1 wt % still retained 94.5% capacity, in comparison with 73.2% for P-NCM622. This further demonstrates the significant improvements provided by the manganese phosphate coating.

### REFERENCES

[1] Qiu, Q.; Huang, X.; Chen, Y.; Tan, Y.; Lv, W., Ceram. Int. 2014, 40 (7, Part B), 10511-10516.
[2] Kong, J.-Z.; Ren, C.; Tai, G.-A.; Zhang, X.; Li, A.-D.; Wu, D.; Li, H.; Zhou, F., J. Power Sources 2014, 266 (0), 433-439.
[3] Uzun, D.; Do\check{g}rusöz, M.; Mazman, M.; Biçer, E.; Avci, E.; Şener, T.; Kaypmaz, T. C.; Demir-Cakan, R., Solid State Ionics 2013, 249-250, 171-176.
[4] Lee, D.-J.; Scrosati, B.; Sun, Y-K., J. Power Sources 2011, 196 (18), 7742-7746.
[5] Hu, G.-R.; Deng, X.-R.; Peng, Z.-D.; Du, K., Electrochim. Acta 2008, 53 (5), 2567-2573.
[6] Lee, J.-G.; Kim, T.-G.; Park, B., Mater. Res. Bull. 2007, 42 (7), 1201-1211.
[7] Shi, S. J.; Tu, J. P.; Tang, Y. Y.; Zhang, Y. Q.; Liu, X. Y.; Wang, X. L.; Gu, C. D., J. Power Sources 2013, 225, 338-346.
[8] Liu, X.; Liu, J.; Huang, T.; Yu, A., Electrochim. Acta 2013, 109, 52-58.
[9] Myung, S.-T.; Lee, K.-S.; Yoon, C. S.; Sun, Y-K.; Amine, K.; Yashiro, H., J. Phys. Chem. C 2010, 114 (10), 4710-4718.
[10] Miao, X.; Ni, H.; Zhang, H.; Wang, C.; Fang, J.; Yang, G., J. Power Sources 2014, 264 (0), 147-154.
[11] Li, L.; Chen, Z.; Zhang, Q.; Xu, M.; Zhou, X.; Zhu, H.; Zhang, K., J. Mater. Chem. A 2015, 3 (2), 894-904.
[12] Huang, Y.; Jin, F.-M.; Chen, F.-J.; Chen, L., J. Power Sources 2014, 256 (0), 1-7.
[13] Cho, W.; Kim, S.-M.; Lee, K.-W.; Song, J. H.; Jo, Y. N.; Yim, T.; Kim, H.; Kim, J.-S.; Kim, Y-J., Electrochim. Acta 2016, 198, 77-83.

1. Coated lithium transition metal oxide material having a continuous coating of manganese phosphate provided on the surface of the lithium transition metal oxide particles and the lithium transition metal oxide particles having a formula according to Formula I below:
LiₐNiₓM_{y}M′_{z}O_{2+b} Formula I
in which:
0.8≤a≤1.2
0.2≤x≤1
0<y≤0.8
0≤z≤0.2
−0.2≤b≤0.2
M is selected from the group consisting of Co, Mn and combinations thereof; and
M′ is selected from the group consisting of Mg, Al, V, Ti, B, Zr, Sr, Ca, Cu and Zn, and combinations thereof.

2. Coated lithium transition metal oxide material according to claim 1, wherein the continuous coating of manganese phosphate has a thickness in the range from 0.5 nm to 15 nm.

3. Coated lithium transition metal oxide material according to claim 2, wherein the continuous coating of manganese phosphate has a thickness in the range from 2 nm to 10 nm.

4. Coated lithium transition metal oxide material according to claim 1, wherein the continuous coating of manganese phosphate is formed from a continuous layer of manganese phosphate material.

5. Coated lithium transition metal oxide material according to claim 1, wherein the continuous coating of manganese phosphate is substantially uninterrupted.

6. Coated lithium transition metal oxide material according to claim 1, wherein the manganese phosphate coating is a MnPO₄ coating.

7. Coated lithium transition metal oxide material according to claim 1, wherein the manganese phosphate coating is deposited from a composition comprising Mn ions and phosphate ions, and wherein the concentration of Mn in the composition is in the range from 0.001M to 0.09M.

8. Coated lithium transition metal oxide material according to claim 1, which exhibits a capacity loss of less than 15% when cycled for 100 cycles at 1 C.

9. Coated lithium transition metal oxide material according to claim 1, which exhibits a lithium ion apparent diffusion coefficient on delithiation of at least 2×10⁻⁸ cm²s⁻¹.

10. A process for providing a continuous coating of manganese phosphate on the surface of lithium transition metal oxide particles having a formula according to Formula I, the process comprising contacting particulate lithium transition metal oxide with a composition comprising Mn ions and phosphate ions, and heating to form the manganese phosphate coating.

11. A process according to claim 10 wherein the concentration of Mn in the composition is in the range from 0.001M to 0.09M.

12. A process according to claim 10 wherein the particulate lithium transition metal oxide is contacted with the composition comprising Mn ions and phosphate ions by a process comprising
providing a solution of Mn ions; then
mixing the solution of Mn ions with particulate lithium transition metal oxide to form a mixture; then
adding a solution comprising phosphate ions to the mixture.

13. A process according to claim 12 wherein the concentration of Mn in the solution of Mn ions is in the range from 0.001M to 0.18M.

14. A process according to claim 10 wherein the process further comprises forming an electrode comprising the coated lithium transition metal oxide material.

15. A process according to claim 14, further comprising constructing a battery or electrochemical cell comprising the electrode.

16. Coated lithium transition metal oxide material according to claim 1 which is obtained or obtainable by a process for providing a continuous coating of manganese phosphate on the surface of lithium transition metal oxide particles having a formula according to Formula I, the process comprising contacting particulate lithium transition metal oxide with a composition comprising Mn ions and phosphate ions, and heating to form the manganese phosphate coating.

17. A cathode for a lithium battery comprising coated lithium transition metal oxide material according to any one of claims 1 to 9claim 1.

18. A battery or electrochemical cell comprising a cathode according to claim 17.
